(19) United States
(12) Patent Application Publication
(10) Pub. No.: US 2014/0108484 A1
(43) Pub. Date: Apr. 17, 2014

(54) METHOD AND SYSTEM FOR OPTIMIZING DISTRIBUTED TRANSACTIONS

(71) Applicant: TIBERO CO., LTD., Gyeonggi-do (KR)

(72) Inventors: Hun Young PARK, Gyeonggi-do (KR); Sang Young Park, Gyeonggi-do (KR)

(73) Assignee: TIBERO CO., LTD., Gyeonggi-do (KR)

(21) Appl. No.: 13/665,004

(22) Filed: Oct. 31, 2012

(30) Foreign Application Priority Data
Oct. 12, 2012 (KR) 10-2012-0112508

(51) Int. Cl. G06F 15/16

(52) U.S. Cl. 709/201

(57) ABSTRACT

A distributed system includes a plurality of nodes; and replicas of the nodes. Each of the nodes transmits a commit log of a transaction to its own replica and receives a reply to the commit log from its own replica to complete a local transaction. In the distributed system, one of the nodes to which a transaction is requested transmits a commit message requesting the commit of the transaction to the remaining nodes. Each of the remaining nodes then performs the commit of the transaction based on the commit message to complete a global transaction.

### FIELD OF THE INVENTION

The present invention relates to optimization of distributed transactions performed in a distributed system, and more particularly, to a distributed system and method for optimizing a commit of a distributed transaction in a distributed system.

Support for the present invention was provided by Ministry of Knowledge Economy in Korea under Project 10040824 [Source Technology Development Business for Industrial Convergence].

### BACKGROUND OF THE INVENTION

A distributed system includes a plurality of nodes that are interconnected with at least two networks, for example, an independent server, a computer, or database systems. The distributed system serves to distribute and execute a transaction that is a single work unit at several nodes interconnected with networks to seem as if a single work is executed. Therefore, contents or results of the transactions generated from each local resource in the distributed system are synchronized with other nodes interconnected with networks. Any one that integrates and manages all the transactions among several nodes plays the role of a coordinator or a master of the transaction and the remaining nodes play the role of a participant or a slave. In view of the transaction, any one that generates a transaction among several nodes becomes a coordinator of the transaction and the remaining systems become a participant.

The distributed transaction performed in the distributed system means that transactions are performed in resources distributed in the network and are generally processed using a 2-phase commit protocol for atomicity of transactions at each node. In the 2-phase commit protocol, a coordinator requests a participant to process each local transaction. The coordinator receives a reply called a success from all the participants in each phase and then, determines whether the transaction succeeds. When all the participants successfully perform the transactions, the phase succeeds and otherwise, the phase fails. When the transaction succeeds, a reply to the commit is transmitted to a user and when the transaction fails, all the participants are requested to abort each local transaction.

The 2-phase commit protocol is generally executed by being divided into two phases. The first phase is a prepare phase. In this phase, the coordinator records the message requesting to prepare the local transaction in its own log and transmits the prepare message to each participant. Each participant receives the prepare messages and records the prepare message in its own log when it may perform the local transaction. The participant then transmits the prepare message to the coordinator.

As such, all the participants and the coordinator permanently leave in the logs that each local transaction reaches the prepare phase. In the above process, if some participants cannot process the local transaction, the coordinator recognizes the failure of the local transaction and requests all the participants to abort their local transactions.

The second phase is a commit phase. The phase is performed after it is confirmed that all the participants and the coordinator are in the prepare phase. The coordinator requests all the participants to perform the commit. Each participant performs the commit and then transmits a reply to the request to the coordinator. In this case, each participant remains information on the commit in its own log for durability.

When the coordinator receives replies that the commit succeeds from all the participants, the coordinator determines that a global commit succeeds. Even though the commit of the local transaction fails in some participants, the commit of the local transaction may succeed in the other participants, and therefore, the coordinator may not immediately determines the success and failure of the commit. In this case, a post-processing work needs to be performed for consistency of the distributed transaction. The post-processing work may depend on a configuration of the distributed system and may include, for example, a presumed abort type and a presumed commit type.

Each participant cannot determine whether the commit of the local transaction is performed after the first phase succeeds and prior to proceeding to the second phase. Thus, even though the distributed system approaches corrected data due to the local transaction, it is impossible to see the data. In other words, since it may determine that each transaction succeeds only when the commit is performed in the second phase, the transaction in the prepare phase seems like a state doing nothing.

The 2-phase commit protocol needs to generate a request-reply set with all the participants twice, which is the obstacle to the performance of the distributed system. In order to solve the above problem, various methods for simplifying the protocol have been proposed.

One of the methods is a 1-phase commit protocol. A 1-phase commit introduces implicit yes-vote that allows the coordinator log and the participants to make the transaction into the prepare phase in advance whenever the transaction is progressed therebetween. In this case, the additional logs remain in the coordinator and the participants and there is a need to change the state of the participants every time a new work enters.

Further, the coordinator's log needs to be recorded in a data storage device such as a hard disk. Hereat, if the performance and speed of the data storage device is relatively low or slow, cycle of the commit is increased.

Recently, as a demand for a large-capacity system is increased, a distributed system environment frequently introduces a replica into the system so as to ensure the durability and availability of data. More specifically, the distributed system environment has a replica for a specific data or machine and thus, provides the same data and service as an original using the replica even under the situation in which it cannot approach the original data or machine.

However, it is very difficult for the distributed system environment having a replica to apply a processing type of the existing distributed transaction. That is, the distributed system needs to be configured to support the 2-phase commit protocol for processing the distributed transaction and add a load required to perform communication between the original and the replica.

### SUMMARY OF THE INVENTION

In view of the above, the present invention provides a system and method for optimizing a commit of a distributed transaction by reducing a commit procedure of the distributed transaction in the distributed system.

In accordance with a first aspect of the present invention, there is provided a method for processing transactions in a distributed system including a plurality of nodes each of which has its own replica, which includes: transmitting, by each node, a commit log of a transaction to its own replica; and receiving, by each node, a reply to the commit log from the replica to complete the commit of the transaction.

In an exemplary embodiment of the method, the transaction is a local transaction.

In an exemplary embodiment of the method, each node has at least one replica so as to ensure durability in the distributed system.

In accordance with a second aspect of the present invention, there is provided a method for processing transactions in a distributed system including a plurality of nodes, wherein each node has its own replica, and one of the nodes plays a role of a coordinate to which a transaction is requested and remaining nodes becomes participants. The method includes: transmitting, by the coordinator, a commit log of a transaction to its own replica; receiving, by the coordinator, a reply to the commit log from the replica; transmitting, by the coordinator, a commit message requesting the commit of the transaction to all the participants; and performing, by each of the participants, the commit of the transaction based on the commit message.

In an exemplary embodiment of the method, the coordinator does not require a reply to the commit message from each participant.

In an exemplary embodiment of the method, the method further includes: acquiring a post confirmation for the commit of the transaction to the coordinator, wherein the post confirmation is acquired by some of the participants that do not receive the commit message transmitted from the coordinator or fails to perform the commit.

In an exemplary embodiment of the method, the acquiring a post confirmation includes: periodically checking, by each participant, whether the commit message is received; inquiring, by each participant, of the coordinator whether the commit message was transmitted when the commit message has not been received; and performing, by each participant, the commit or abort of the transaction according to a reply to the inquiry from the coordinator.

In an exemplary embodiment of the method, each of the replicas is configured to process the transaction, instead of its original when the original fails to conduct its function.

In accordance with a third aspect of the present invention, there is provided a distributed system including: a plurality of nodes; and replicas of the nodes. Each of the nodes transmits a commit log of a transaction to its own replica and receives a reply to the commit log from its own replica to complete a local transaction.

In an exemplary embodiment of the method, one of the nodes plays a role of a coordinate to which the transaction is requested and remaining nodes becomes participants, and wherein the coordinate node is configured to transmit a commit message requesting the commit of the transaction to the participants, and each of the participants performs the commit of the transaction based on the commit message to complete a global transaction.

In an exemplary embodiment of the method, each of the participants is configured so as not to perform a reply to the commit message from the coordinator.

In an exemplary embodiment of the method, each of the participants is configured to: periodically check whether the commit message was received; if it is checked that the commit message has not been received, inquire of the coordinator whether the commit message was transmitted; and perform the commit or abort of the transaction according to a reply to the inquiry from the coordinator.

In an exemplary embodiment of the method, each of the replicas is configured to process the transaction, instead of its original when the original does not perform its function.

### BRIEF DESCRIPTION OF THE DRAWINGS

The above and other objects and features of the present invention will become apparent from the following description of embodiments given in conjunction with the accompanying drawings, in which:

FIG. 1 illustrates a schematic block diagram of a distributed system to which the present invention is applied;

FIG. 2 shows a detailed block diagram of each node illustrated in FIG. 1;

FIG. 3 is a sequence diagram illustrating a method for optimizing a commit of a distributed transaction in accordance with an embodiment of the present invention; and

FIG. 4 is a sequence diagram illustrating a method for receiving an additional confirmation of a transaction commit from a coordinator so as to cope with a lost commit message in accordance with the embodiment of the present invention.

### DETAILED DESCRIPTION OF THE EMBODIMENTS

Hereinafter, embodiments of the present invention will be described in detail with reference to the accompanying drawings.

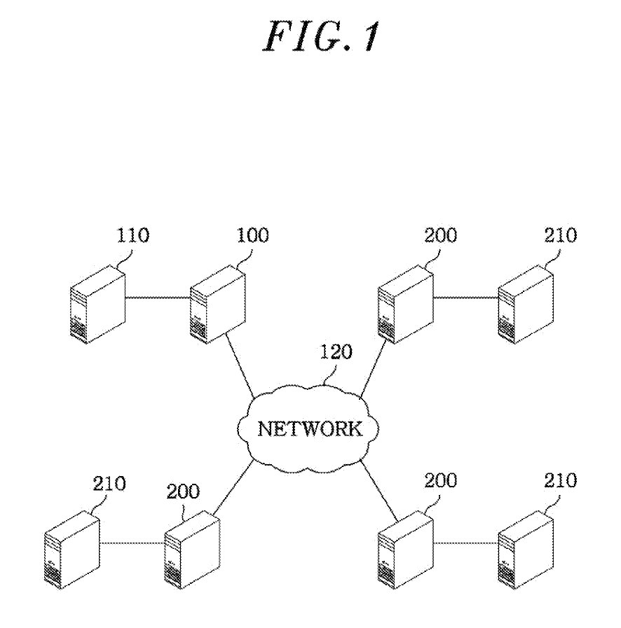

FIG. 1 illustrates a schematic block diagram of a distributed system to which the present invention is applied. As illustrated in FIG. 1, the distributed system includes a plurality of nodes 100 and 200 that are interconnected with a network 120, for example, a server, a computer system, or database systems.

Any one that integrates and manages all the transactions among the plurality of nodes 100 and 200, for example, the node 100 serves as a coordinator or a master of the transaction and the remaining nodes 200 serve as a participant or a slave that participates in the transaction.

The nodes 100 and 200 have their own replicas 110 and 210. The nodes 100 and 200 serve an original against their replicas. The nodes 100 and 200 have the same components with each other. Similarly, the replicas 110 and 210 have also the same components with each other. In addition, the replicas 110 and 210 synchronize transactions with their corresponding original 100 and 200, respectively, in real time. In other words, since the distributed system is configured of an original and a replica, when data are corrected at the originals 100 and 200, logs for the corrected data are generated and the logs are transmitted to the replicas 110 and 210. Therefore, identity of data with the originals 100 and 200 may be maintained in the replicas 110 and 210.

The replicas 110 and 210 exist so as to increase data durability of the distributed system and commit performance of a local transaction performed in the originals 100 and 200. The logs generated at the time of performing the local transactions in the originals 100 and 200 are transmitted to the replicas 110 and 210 instead of being recorded in permanent recording media, such as, for example, hard disks or the like of the originals 100 and 200 such that durability is ensured. Further, the replicas 110 and 210 are used to manage the distributed transactions instead of the originals 100 and 200 when the originals 100 and 200 lose unique functions due to a failure or the like. That is, even though the originals 100 and 200 are broken, the replicas 110 and 210 execute a role of the originals 100 and 200 to generate data based on the logs which have been transmitted from the originals 100 and 200, such that the durability of data can be ensured in the distributed system.

The number of replicas belonging to the originals 100 and 200 may be set according to the distributed system so as to permanently preserve the logs. For example, the number of replicas is generally provided to be about 2 and 3 according to safety defined in the distributed system.

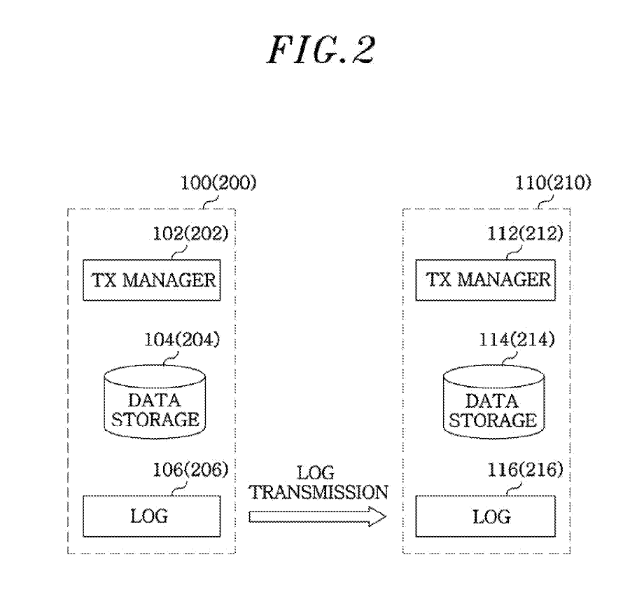

FIG. 2 shows a detailed block diagram of each node illustrated in FIG. 1. The nodes 100 and 200 include transaction managers (TX managers) 102 and 202, data storages 104 and 204, and logs 106 and 206, respectively. Similarly, the replicas 110 and 210 of the nodes 100 and 200 include transaction managers 112 and 212, data storages 114 and 214, and logs 116 and 216, respectively.

The data storages 104 and 204 of the nodes 100 and 200 store data associated with the transactions performed in the distributed system.

The logs 106 and 206 of the nodes 100 and 200 are files or repositories in which information on when nodes are connected, what works are performed, and the like, is stored.

The data storages 114 and 214 of the replicas 110 and 210 store data synchronized with the data stored in the data storages 104 and 204 of the nodes 100 and 200.

The logs 116 and 216 of the replicas 110 and 210 perform the same functions as the logs 106 and 206 of the nodes 100 and 200. The transaction managers 102 and 202 of the nodes 100 and 200 have different functions according to a role of a coordinator or participants. For example, if the node 100 plays a role of a coordinator, the transaction manager 102 of the node 100, i.e., the coordinator serves to coordinate communication between the coordinator 100 and all the participants 200. Therefore, the transaction manager 102 of the coordinator 100 needs information on transaction performed in the participants 200 and information on a system of the participants 200. When the nodes 200 become a participant, the transaction manager 202 of the nodes 200, i.e., the participants needs system information of the coordinator 100.

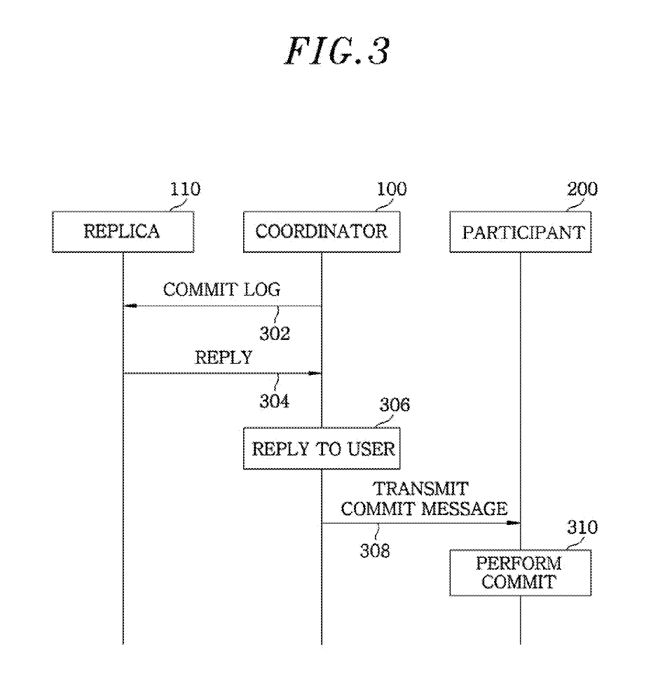

FIG. 3 is a sequence diagram illustrating a method for optimizing a commit of a distributed transaction in accordance with an embodiment of the present invention. In FIG. 3, the node 100 is assumed to be a coordinator to which a transaction is requested by a user and the nodes 200 is assumed to be participants.

First, in operation 302, the transaction manager 102 of the coordinator 100 transmits the commit log of the transaction to the replica 110 of the coordinator 100. The commit log of the coordinator 100 transmitted to the replica 110 is permanently preserved, instead of not being recorded in the coordinator 100, for example, a storage medium such as hard disks of the coordinator 100. Therefore, a burden of the coordinator that permanently preserves the commit logs generated in the coordinator can be relieved. However, it will be appreciated to those skilled in the art that the commit log of the coordinator may also be implemented to be recorded in the storage medium of the coordinator 100.

In operation 304, the transaction manager 102 of the coordinator 100 receives a reply that indicates a receipt of the commit log from the transaction manager 112 of the replica 110.

In operation 306, the transaction manager 102 of the coordinator 100 transmits a commit reply of the transaction to a user to notify the completion of the transaction requested by the user. The user can recognize that the commit (transaction) has been completed from the notice.

Therefore, the commit of a local transaction may be completed by performing the foregoing set of commit request and commit reply with the coordinator and its own replica once.

Thereafter, in operation 308, for performing a global transaction, the transaction manager 102 of the coordinator 100 transmits a transaction commit message requesting the commit of the transaction to all the participants 200. In accordance with the embodiment of the present invention, the transaction commit message transmitted from the coordinator 100 to the participant 200 is a commit request that does not require a reply from the respective participants 200. The transaction commit message transmitted to the participants is used for maintaining minimum compatibility in the distributed system.

In operation 310, each participant 200 progresses a commit by oneself in response to the transaction commit message. However, as described above, each participant 200 does not transmit a reply to a commit to the coordinator 100.

When the commit of the transaction is progressed in the respective participants 200, each of the participants 200 transmits the commit log to its corresponding replica 210 by the same method as one performed in the foregoing operation 302 to ensure the commit of the local transaction. As set forth above, therefore, it is possible to optimize the commit procedure of the local and global transactions performed in the distributed system.

Meanwhile, in the foregoing operation 308, a loss of the commit message may occur during the transmission of the commit message from the coordinator 100 to each participant 200. The loss of the commit message may occur when the commit message from the coordinator 100 does not reach some of the participants or when the commits may not be progressed in the participants even though the participants receives the commit message. An example of the case in which the commits may not be progressed in the participants may include a disconnection of a session between the coordinator and the participants, a failure of a power supply in the participants, and the like.

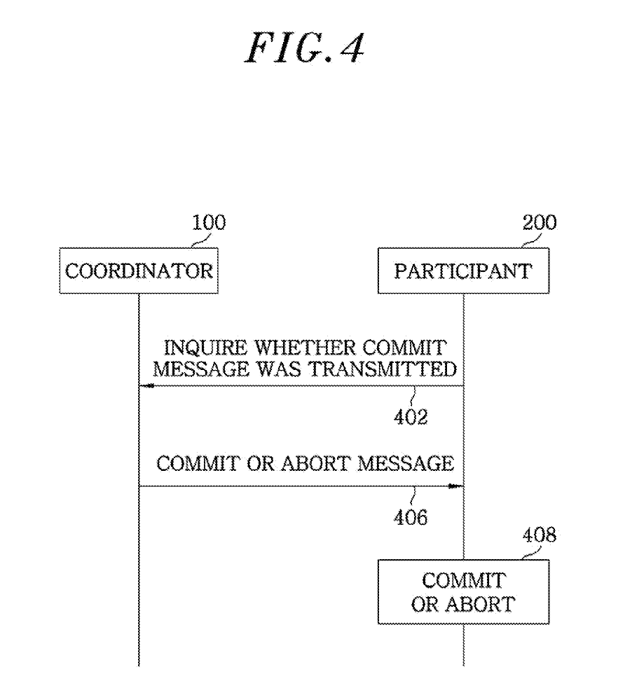

FIG. 4 is a sequence diagram illustrating a method for acquiring a post confirmation of the transaction commit from the coordinator so as to cope with the loss of the commit message in accordance with the embodiment of the present invention.

In FIG. 4, the participants 200 are assumed to be the participants that do not receive the commit message from the coordinator 100 or cannot progress the commit.

Prior to the acquisition of the post confirmation of the transaction commit, the problems in the participants need to be first solved. For example, a procedure of recovering the session with the coordinator or recovering the failure of a power supply of the participants should be preceded.

The transaction manager 202 of each participant 200 periodically checks whether the commit message is received. If it is checked that the commit message is not received, the transaction manager 202 of the participant 200 expects that there may be an unknown commit message of the transaction that might be needed to perform in the participant.

In operation 402, the transaction manager 202 of the participant 200 inquires of the transaction manager 102 of the coordinator 100 whether the commit message of the transaction was transmitted.

The transaction manager 102 of the coordinator 100 then checks the state of the transaction manager 202 of the participant 200 to determine whether the transaction inquired from the participant 200 needs to be committed or aborted. In operation 406, if it is determined that the transaction to be performed in the participant 200 needs to be committed, the transaction manager 102 of the coordinator 100 transmits a message requesting a commit to the transaction manager 202 of the participant 200; however, if it is determined that the transaction to be performed in the participant 200 needs to be aborted, the transaction manager 102 of the coordinator 100 transmits a message requesting an abort to the transaction manager 202 of the participant 200.

Next, in operation 408, the transaction manager 202 of the participant 200 confirms the message transmitted from the transaction manager 102 of the coordinator 100 and performs the commit or abort of the transaction pursuant to the message.

When the commit or the abort is progressed in the participant 200, the participant 200 transmits the commit log to its own replica 210 and ensures the commit of the transaction by a method for receiving a reply from the replica 210 as illustrated in FIG. 3.

Therefore, when some of the participants do not receive the commit request from the coordinator or fails to perform the commit, consistency in the distributed system may be completely implemented by acquiring the post confirmation from the coordinator.

As set forth above, in accordance with according to the embodiments of the present invention, the distributed system including a replica may overcome the disadvantage of the 2-phase commit and ensure the compatibility of data.

Further, it is possible to rapidly perform the commit procedure over the prior art and relieve the burden of generating the new log every time so as to change the state of the participants.

While the invention has been illustrated and described with respect to the preferred embodiments, the present invention does not limited thereto. It will be understood by those skilled in the art that various changes and modifications may be made without departing from the scope of the invention as defined in the following claims.

What is claimed is:

1. A method for processing transactions in a distributed system including a plurality of nodes, each node having its own replica, the method comprising:
transmitting, by each node, a commit log of a transaction to its own replica; and
receiving, by each node, a reply to the commit log from the replica to complete the commit of the transaction.

2. The method of claim 1, wherein the transaction is a local transaction.

3. The method of claim 1, wherein each node has at least one replica so as to ensure durability in the distributed system.

4. A method for processing transactions in a distributed system including a plurality of nodes, wherein each node has its own replica, and one of the nodes plays a role of a coordinate to which a transaction is requested and remaining nodes becomes participants, the method comprising:
transmitting, by the coordinator, a commit log of a transaction to its own replica;
receiving, by the coordinator, a reply to the commit log from the replica;
transmitting, by the coordinator, a commit message requesting the commit of the transaction to all the participants; and
performing, by each of the participants, the commit of the transaction based on the commit message.

5. The method of claim 4, wherein the coordinator does not require a reply to the commit message from each participant.

6. The method of claim 4, further comprising:
acquiring a post confirmation for the commit of the transaction to the coordinator,
wherein the post confirmation is acquired by some of the participants that does not receive the commit message transmitted from the coordinator or fails to perform the commit.

7. The method of claim 6, wherein said acquiring a post confirmation comprises:
periodically checking, by each participant, whether the commit message is received;
inquiring, by each participant, of the coordinator whether the commit message was transmitted when the commit message has not received; and
performing, by each participant, the commit or abort of the transaction according to a reply to the inquiry from the coordinator.

8. The method of claim 4, wherein each of the replicas is configured to process the transaction, instead of its original when the original fails to conduct its function.

9. A distributed system, comprising:
a plurality of nodes; and
replicas of the nodes,
wherein each of the nodes transmits a commit log of a transaction to its own replica and receives a reply to the commit log from its own replica to complete a local transaction.

10. The distributed system of claim 9, wherein one of the nodes plays a role of a coordinate to which the transaction is requested and remaining nodes becomes participants, and
wherein the coordinate is configured to transmit a commit message requesting the commit of the transaction to the participants, and each of the participants performs the commit of the transaction based on the commit message to complete a global transaction.

11. The distributed system of claim 10, wherein each of the participants is configured so as not to perform a reply to the commit message from the coordinator.

12. The distributed system of claim 10, wherein each of the participants is configured to:
periodically check whether the commit message is received,
if it is checked that the commit message has not been received, inquire of the coordinator whether the commit message was transmitted; and
perform the commit or abort of the transaction according to a reply to the inquiry from the coordinator.

13. The distributed system of claim 9, wherein each of the replicas is configured to process the transaction, instead of its original when the original does not perform its function.
